(19) United States
(12) Patent Application Publication
(10) Pub. No.: US 2009/0006206 A1
(43) Pub. Date: Jan. 1, 2009

(54) Systems and Methods for Facilitating Advertising and Marketing Objectives

(76) Inventors: Ryan Groe, Irvine, CA (US); Gavenraj Sodhi, Ladera Ranch, CA (US); Walter Groth, Laguna Niguel, CA (US)

Correspondence Address: FISH & ASSOCIATES, PC;ROBERT D. FISH, 2603 Main Street, Suite 1050, Irvine, CA, 92614-6232, US

(21) Appl. No.: 12/140,073

(22) Filed: Jun. 16, 2008

Related U.S. Application Data
(60) Provisional application No. 60/944,039, filed on Jun. 14, 2007.

(51) Int. Cl. G06F 17/30; G06Q 30/00

(52) U.S. Cl. 705/14

(57) ABSTRACT

A system and method for leveraging personal information published on social networking sites leverage gleaned psychographic profile information to produce revenues for both social networking sites and content producers. Personal information on every web page of the site is analyzed automatically to categorize publishers as belonging to one or more psychographic profiles that correspond to marketed products. Advertisers can then cater advertisements to psychographic profiles to better target a market audience, and information on psychographic profiles can be improved by tracking changes to the personal information over time. Psychographic profiling can also help filter desired media content towards publishers and/or advertisers.

This invention claims priority to provisional application Ser. No. 60/944,039, filed Jun. 14, 2007, which is incorporated by reference in its entirety.

### FIELD OF THE INVENTION

The field of the invention is electronic advertising.

### BACKGROUND

It is known in the art to target ads towards a specific demographic audience. For example, TV commercials are frequently targeted towards a specific age and gender depending on the time of day the commercial is playing. Commercials during the daytime may focus more on young children and their parents, while commercials late at night may focus on young adults in their 20's and 30's. Hundreds of millions of dollars are spent each year simply gleaning demographic information about viewers of television programs, magazines, and newspapers in order for advertisers to target an audience that would be more interested in the advertised product. With the advances in technology, advertisers are able to obtain better demographic information to better target advertisements.

US 2006/0085408 to Morsa teaches a system and method of surveying users for demographic and psychographic information, and sending that user advertisements based upon that information. Morsa, however, asks each user to fill out a questionnaire for the purpose of receiving individually catered advertisements. Few members of the public voluntarily fill out surveys and questionnaires to increase the number of advertisements sent to them without some sort of compensation. Morsa and all other extrinsic materials identified herein are incorporated by reference in their entirety. Where a definition or use of a term in an incorporated reference is inconsistent or contrary to the definition of that term provided herein, the definition of that term provided herein applies and the definition of that term in the reference does not apply.

US 2007/0067297 to Kublickis teaches a system and method of obtaining demographic information from user profiles on an internet website. Once user profiles are created, the website can then cater its advertising content to match the visitors coming to the website. Some websites exist, however, where the publisher of the website might view the website more often than visitors do, for example blogs and social networking websites. In such situations, it could be much more advantageous for an advertiser to cater the advertisements towards the publisher of the website instead of towards the visitors to the website.

With the advent of social networking websites and blogs, there exist more publishers of web pages than ever before that enjoy publishing their own personal information on public or restricted web pages. While a select few social networking web sites and blogs receive a great deal of traffic, some do not and are frequented more often by the publisher of the web page than by third parties. In such a case, advertising becomes more effective if it's aimed towards the publisher and not towards visitors to the web page. A person of ordinary skill in the art will appreciate that the term “publishers” is used herein to refer to human beings. Thus, there is still a need for systems and methods of matching advertisements to publishers of web pages.

### SUMMARY OF THE INVENTION

The present invention provides systems and methods for facilitating advertising and marketing objectives on a public package switched network, preferably the Internet. More particularly, the present invention performs an automatic analysis on web pages on a social networking site to create psychographic profiles and associate the profiles with market items. These psychographic profiles can be utilized by advertisers improve their targeted advertising and customer database, as well as by social networking admits to improve the experience of the users.

The personal information posted by a publisher could include many different kinds of information, for example a name, age, geographic location, hobbies, interests, television shows, movies, favorite music, favorite books, favorite quotes, and pets. While personal information could be presented in text format as text objects, other presentation methods have been found to be more illustrative, for example using audio files, podcasts, images, animations, and videos. Publishers can even post content that was created by non-publishers, for example a speech by an inspirational presidential candidate. All this information is very valuable to glean for psychographic information, and is frequently posted voluntarily by the publisher.

Psychographic profiles are different from demographic profiles. Generally, a demographic profile has categorical representations, for example age, race, gender, religion, and income. In contrast, a psychographic profile has subtle characteristics of what a target group cares about or how a target group feels, values, or lives. This data could be derived from demographic data, but is more relevant than demographic data when establishing correlations with purchasers of market items. As used herein, a “market item” is a product or service offered for money. A market item should not be confused with a person or an opportunity to meet a person, as is the case in so many Internet dating websites.

In a preferred embodiment, psychographic profiles are created by a computer algorithm that is automatically applied to a plurality of web pages on a social networking site. “Automatically applying” a computer algorithm preferably comprises having the analysis run without any human interaction, but could mean that the computer is used for only a part of the time, for example when a computer harvests raw data and creates an organized report for a marketing professional to analyze. The computer algorithm could be run every time there is a change to a web page, but is more preferably run periodically, for example every 5 seconds, every minute, every hour, every day, or every week. Since groups of publishers can generally be grouped into similar psychographic profiles, there are generally fewer psychographic profiles than there are publishers. The number of psychographic profiles can vary, and can be as little as 10 or as many as 100 or even 1000 or more.

Algorithms are also preferably automatically applied to market items to help characterize the personality of that market item. The process of characterizing a market item generally involves extracting objective and/or subjective data about a market item to create the personality. As used herein, a “personality” includes those characteristics that attract a buyer, for example price, quality, and service. Each personality can be matched with one or many psychographic profiles of publishers that are attracted to that “personality.” It is even possible for a personality to be so universally attractive, that members of all psychographic profiles are attracted to that “personality,” although such matches are exceedingly rare.

Matches between personalities and psychographic profiles can be very valuable to advertisers. For example an advertiser could place an advertisement on all web pages whose publishers have a psychographic profile that is attracted to a market item's personality. If a publisher's psychographic profile changes, the advertisements could be dynamically altered as the changes are being made, or at specified times. Changes to the personal information or the psychographic profile could be recorded so that advertisers could see how its customers' tastes and preferences change over time. Trends in commonly published content can also help educate advertisers on what types of advertisements would be the most effective to certain publishers. An algorithm could even be developed that identifies publishers who have already purchased a market item, to help identify other psychographic profiles of potential customers that may not be known. Every one of these services and more are worth hundreds of thousands of dollars in untapped market research data, for which advertisers would gladly pay a premium on.

Leveraging publisher's psychographic profiles can also benefit publishers on social networking sites. Psychographic profiles could also be matched with content created by non-publishers or third-party content providers, for example videos on Youtube™ or songs on Myspace™. A publisher's psychographic profile could indicate that he prefers certain kinds of content over others, which are then offered to the publisher for convenience. The publisher can then post that content on his web page in an easy and convenient manner, without having to put much effort into searching for desirable content to post. Widgets can also be created and installed on a third-party's website that provides a user interface that allows the publisher, content provider, or any other suitable party to send chosen content to the publisher's web page. By tracking use of the widgets, the correlation between publisher's psychographic profiles and the types of content they prefer can be strengthened over time.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is an exemplary social networking web page.

FIG. 2 is a diagram of a psychographic analyzer connected to a series of social network databases to create a series of psychographic profiles.

FIG. 3 is a diagram of a market item analyzer connected to a series of market items to create a series of personalities

FIG. 4 is a diagram of matched market item personalities with psychographic profiles.

FIG. 5 is a diagram of matched content with psychographic profiles.

FIG. 6A-6D shows a widget installed as a user interface to bridge social networking web pages with advertising opportunities

FIG. 7A shows the widget of FIG. 6A that links to a contest link.

FIG. 7B shows the linked contest of FIG. 7A.

FIG. 8 shows methods of leveraging the invention to create value.

### DETAILED DESCRIPTION OF THE DRAWING

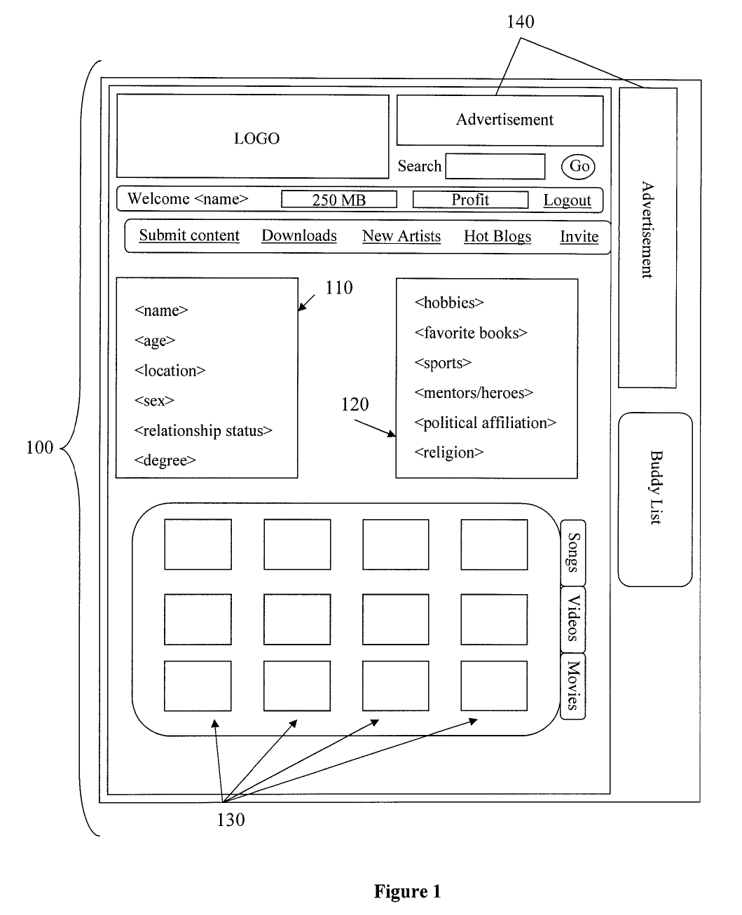

In FIG. 1, a social networking web page 100 generally comprises demographic information 110, psychographic information 120, linked content 130, and advertisements 140. Social networking web page 100 is typically hosted on a social networking site on the Internet, or other appropriate packet switched network. While a web page could be posted for anyone with access to the Internet to read, for example a personal blog or a publicly posted Myspace™ profile, the content of web pages is typically restricted to a few selected “friends” who utilize the social network. Some web pages are restricted from being read by anyone except the publisher, for example in the case of on-line diaries that are updated nightly. The more private a social networking web page, the more likely that the primary viewer of the web page is the publisher him/herself. In such situations, advertisers would more likely than not cater the advertisements to the publisher than do some other demographic.

The personal information of the publisher of web page 100 generally has a combination of demographic information 110, psychographic information 120, and linked content 130. Demographic information generally describes physical and tangible characteristics, for example age, birth date, race, gender, income, education level, schools attended, jobs had, locations visited, marital status, occupation, geographic area, household size, number of children, and age of children. In contrast, psychographic information generally describes the publisher's attitude, behavior, values, emotions, lifestyles, and other more intangible characteristics, for example hobbies, favorite books, favorite movies, favorite TV shows, favorite music, favorite games, favorite sports, favorite pets, favorite videos, favorite gadgets, favorite cars, mentors/heroes, political affiliation, religion, priorities, and Myers-Briggs Type Indicator (MBTI) score. The type of linked content 130 that is posted on the web page also helps define a publisher's psychographic profile. It should be appreciated that the types of personal information that a publisher provides on a web page is virtually limitless, as publishers frequently publish anything that tickles their fancy, especially on blogging websites.

Similarly, methods of presenting and viewing the personal information are also not limited to any particular medium. Personal information can be placed in any suitable configuration or manner on the web page, and may be conveyed in any suitable medium, from text objects to audio files, podcasts, images, animations, and videos. It should be appreciated that linked content 130 can be content that is either created by the publisher, or by a non-publisher, but is generally placed on the web page with the consent of the publisher, and thus is an indicator of a publisher's psychographic preferences.

Advertisements 120 can also be placed on a web page, typically by an administrator of the social networking website or an automated advertising service, but can also be placed on a web page by a publisher or a third party. While advertisements 120 are shown as at the top or the side of the web page, advertisements can be placed in any configuration in any part of the web page. Generally, advertisements are placed to help pay for running and maintaining a web site or series of web sites, and theoretically increase network traffic from the web page 100 to an advertiser's web page (not shown).

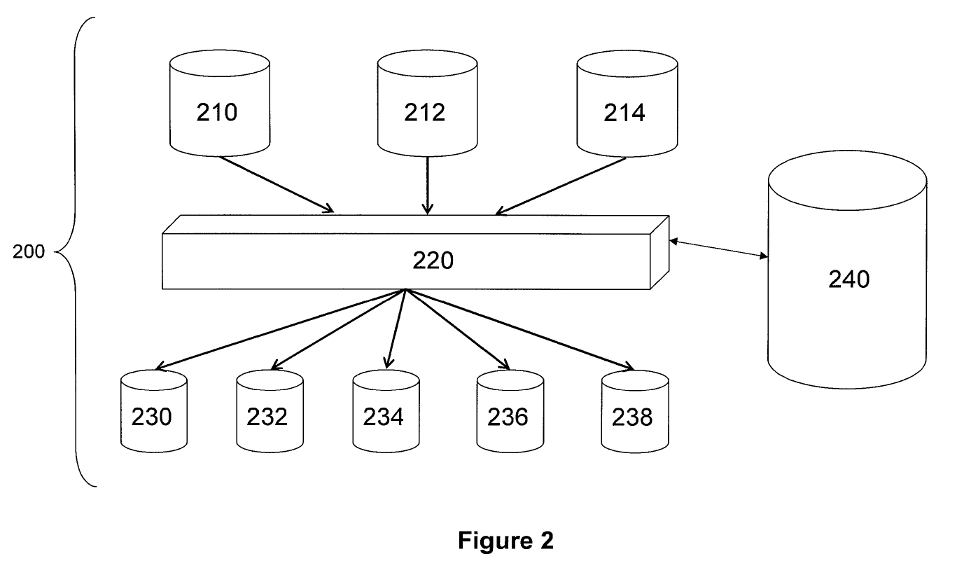

Social networking websites generally have hundreds if not thousands and millions of web pages, each dedicated to a separate publisher. In FIG. 2, a psychographic analyzer 220 automatically examines social networking databases 210, 212, and 214, to create psychographic profiles 230, 232, 234, 236, and 238. Each social networking database 210, 212, and 214 generally corresponds to a different social networking web site. For example, database 210 could house personal information on all MySpace™ users, database 212 all Facebook™ users, and database 214 all LinkedIn™ users. It should be appreciated that a single publisher could have web pages in one, some, or all of the social networking databases 210, 212, and 214. It is preferred that psychographic analyzer 220 cross-references publishers across databases to collect consolidated personal information that is stored in consolidated database 240. In a preferred embodiment, consolidated database 240 stores a publisher's personal information over time. Keeping track of the changes to a publisher's personal information is especially useful for marketing and trend analytics, as well as for testing updated psychographic algorithms and analytics.

Psychographic analyzer 220 can collect information from databases 210, 212, and 214 in many suitable manners. In an exemplary embodiment, psychographic analyzer uses an API to directly access a master database for each social networking site. Alternatively, psychographic analyzer could be given access to each web page and could perform “screen scraping” analytics. For non-text content, particularly the linked content, psychographic analyzer will preferably only collect text metadata, but could conceivably download the actual content, or perform analytics to glean metadata. One example of using analytics to glean metadata is to use a speech recognition program on an audio file to create text metadata. This is particularly useful to glean information from a publisher's video blog.

Psychographic analyzer 220 preferably records changes in personal information as the publisher is entering information in the social networking web site, but more practically records changes periodically, for example once every 30 seconds, once every minute, once every hour, once every day, or once every couple of weeks. It is contemplated that social networking web sites may already keep historical changes to personal information, in which case psychographic analyzer 220 could interface that database instead of collecting information itself.

Once psychographic analyzer 220 has collected relevant personal information from social networking databases 210, 212, and 214, psychographic analyzer can perform analytics to assign at least one psychographic profile 230, 232, 234, 236, and 238, to each of the publishers. Each publisher could have a unique psychographic profile created for him/her, or more preferably a series of pre-designated psychographic profiles are created by a psychographic expert, and each publisher is assigned to one or more psychographic profiles depending on their personal information. The psychographic analytics (not shown) used to categorize and assign publishers could be completely software driven and automatic, but is preferably created with the aid of a psychologist or other similar expert after analyzing various market data. In a preferred embodiment, the psychographic analytics used by the psychographic analyzer is updated every few months to a year, to utilize the latest advances in the field and take advantage of new, updated information on psychographic relationships.

Psychographic profiles 230, 232, 234, 236, and 238 generally enable a market analyzer to better define a publisher's attitudes, for example the publisher's need for social status, the role of money in the publisher's life, the publisher's moral compass, whether or not the publisher is a risk taker or is conservative, or whether or not the publisher is spendthrift or a hoarder of money. All of this information and more can be gleaned from applying appropriate psychographic analytics on personal information commonly posted on social networking web sites.

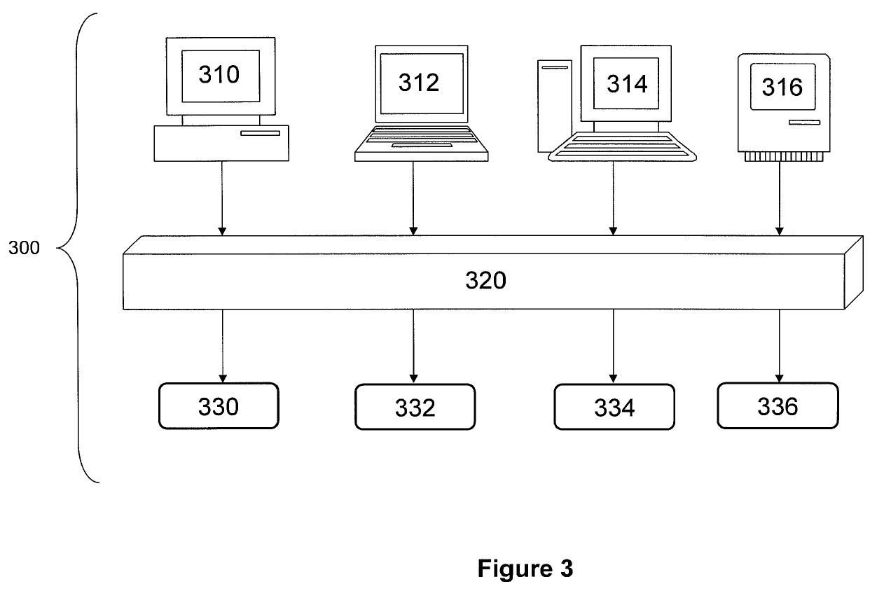

Similarly to psychographic analyzer 220, a market item analyzer 320 in FIG. 3 analyzes a series of market items 310, 312, 314, and 316 to create a series of personalities 330, 332, 334, and 336. A “personality” of a market item is a characteristic of that market item that is commonly taken into consideration by consumers, for example a market item could be relatively expensive and of high quality, could be rather cheap but effective, or could be unique but not universally appealing. Preferably, a personality is created for each market item. However, like the psychographic profiles, multiple market items could be assigned to a common personality, for example when a corporation brands a “suite” of products that are offered together or are commonly associated with one another, or when consumers commonly group products with one another. While the market items 310, 312, 314, and 316 used in the exemplary drawing are different types of computer products, any suitable market item can be analyzed using market analyzer 320.

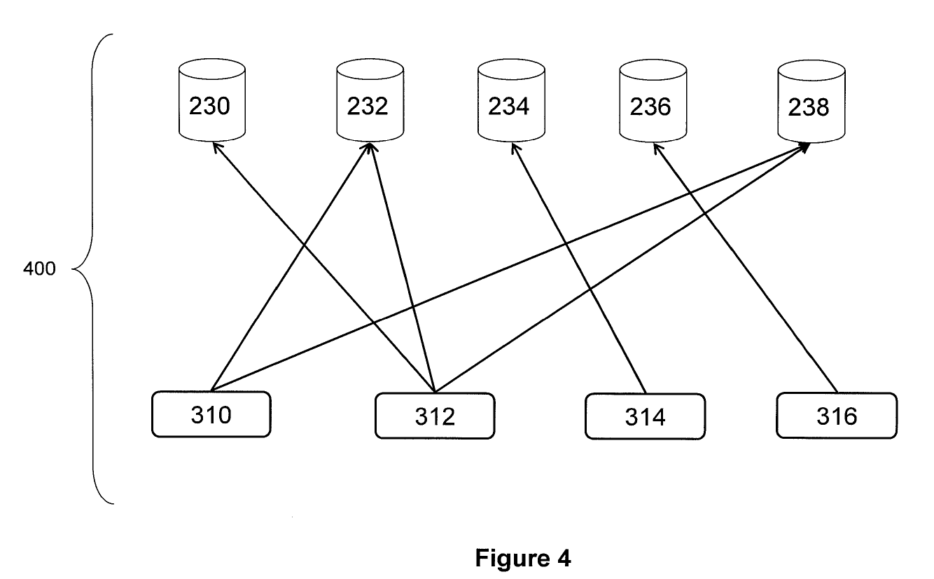

In FIG. 4, psychographic profiles 230, 232, 234, 236, and 238 are matched with personalities 310, 312, 314, and 316. Matching can be performed as simply as correlating descriptive tags between psychographic profiles and personalities. For example, a psychographic profile of a high-end lifestyle user who values sophistication over cost could be matched with a high-end computer with high customer satisfaction but is overly expensive. The matching is preferably done automatically using a software matching algorithm, but could be performed using a dedicated market analyst or team of market analysts.

Since human beings make decisions, particularly purchasing ones, based on emotional and feeling-based criteria, such as their belief systems, habits, and core values, all of which are elements that are captured by psychographics, the correlations made using such data are much stronger. Using psychographic profiles offers insight to match publishers with the right brands, allowing for the tailoring of messages to achieve the highest possible response rate and conversion. Matching allows social networking websites to know which advertisers are the most appropriate to solicit for its users, and allows advertisers to know which users would be their most effective target audience, and would also know how better to tailor their message to a psychographic, and not a demographic, profile.

Additionally, non-competing advertisers can be informed of potential co-branding opportunities. For example, personalities 310 and 312 have two common psychographic profiles, indicating that similar publishers purchase both products. The advertisers could engage in a joint campaign promoting one another's products, expanding both customer bases and bringing value to one another. It should be appreciated that by acting as a middleman between an advertiser and a social network, the publisher's privacy is protected from the advertiser knowing personal and private information about each individual publisher while meaningfully delivering targeted advertising campaigns.

In an exemplary embodiment, the matching algorithm is updated or even created from scratch by analyzing personal information. Personal information not only provides information by which a psychographic profile can be created, but could also inform analysts that a publisher has purchased or is seriously thinking about purchasing a market item. Such information is commonly found in blogs or in status updates. In those cases, correlation is not only indicative that a psychographic profile is attracted to a type of personality, but is probative!

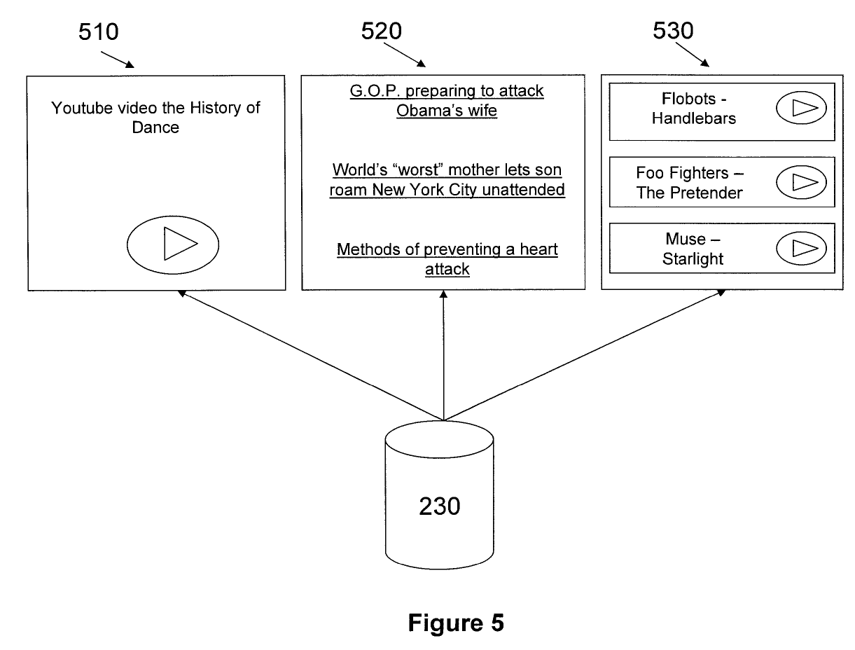

It is contemplated that the same market item analyzer and matching algorithm could be applied to content as well as market items. In FIG. 5, psychographic profile 230 is matched with linked content 510, 520, and 530. A web application providing “content you would like” could be provided to publishers that are assigned to that psychographic profile, which improves the experience for the publisher as not only advertisements are more targeted and relevant towards him/her, but also more attractive content that he/she could publish on the web page is provided as well. Improving the experience of the publisher on the social networking web site is of great value to any owner of a social networking website.

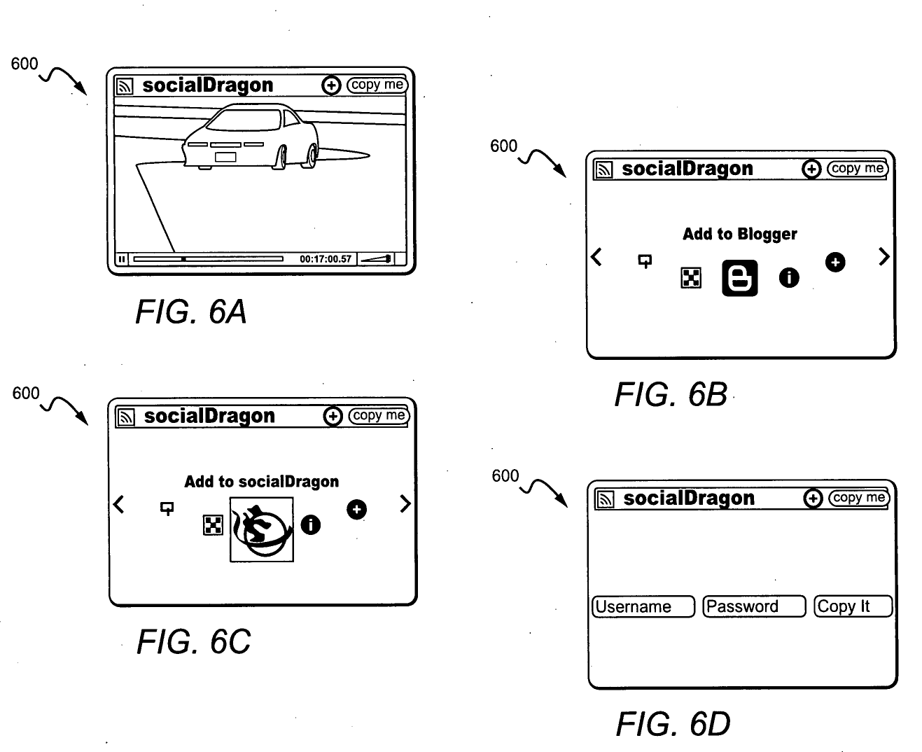

FIGS. 6A-6D show a widget 600 that could be installed on a social network's or advertiser's web page that bridges publishers with a psychographic profile with an advertisement for a matched personality. In FIG. 6A, widget 600 displays a commercial for a car. Clicking “play” on the commercial will show the commercial. Preferably the widget keeps track of how the publisher interacts with the commercial, for example whether or not the publisher clicks play, how much of the commercial is watched, and how many times the commercial is watched. Such data is preferably stored in a database (not shown) that could create reports to both social networking sites and advertisers for auditing and market analysis purposes. Advertisers would not only target audiences with their advertisements, but would also receive metric information that would inform the advertiser exactly how useful the advertisement really is on the social networking web page.

In FIG. 6B, the publisher selects an option to add the commercial to his/her blogging website, and in FIG. 6C, the publisher selects to add the commercial to his/her own or another social networking website. It is contemplated that publishers can interact with advertisements in any suitable way, for example downloading the commercial, forwarding the commercial to friends, or visiting the advertiser's web site. In FIG. 6D, the publisher inputs his/her personal username/password information to authorize the selection.

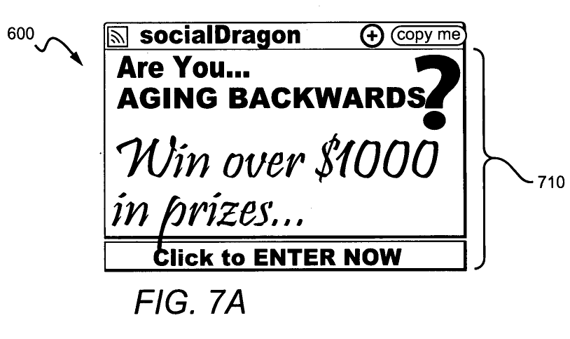

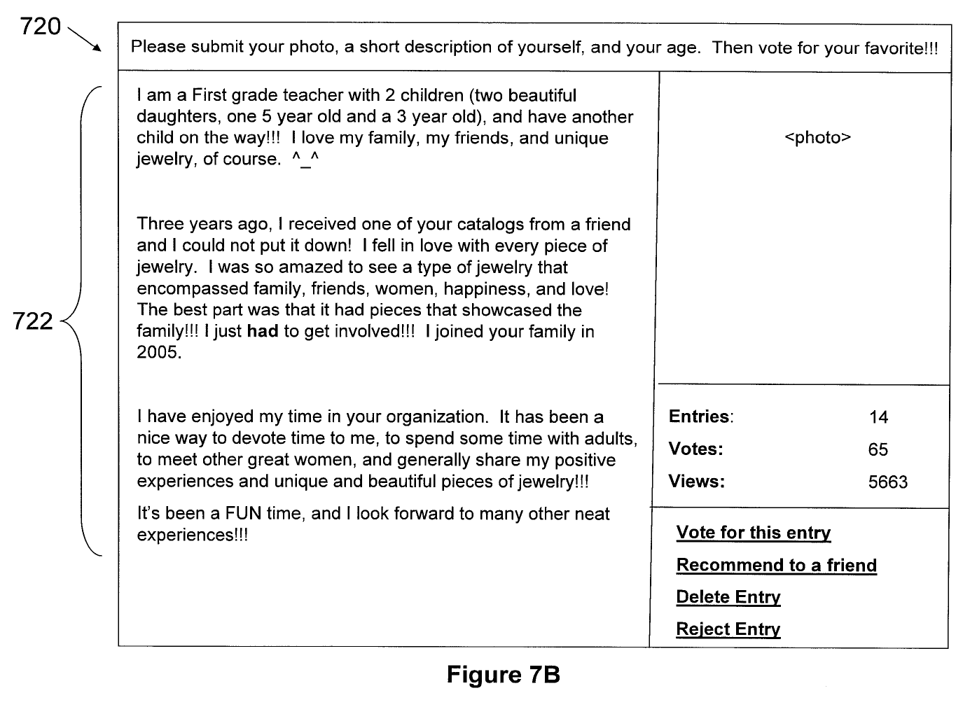

In FIGS. 7A and 7B, the widget is a link to a contest that allows the publisher to enter a contest that requires the completion of a survey, or submission of other personal information that can be used to update his/her psychographic profile. FIG. 7A shows widget 600 with a contest link 710 to a contest asking a publisher to submit a story about himself/herself that can be voted on. FIG. 7B shows contest entry 720 with personal information 722 that can be scanned and gleaned by the widget and sent to a psychographic analyzer. It should be appreciated that widgets can obtain a variety of personal information with the consent of the publisher, for example by having the publisher participate in a brand's campaign, promotion, focus group, or market intelligence study.

It is contemplated that widget 600 with contest link 710 can be placed on any website, allowing for both publishers and viewers of the publisher's content to interact with the widget. Viewers who use the widget, who do not yet have a psychographic profile created, could have a psychographic profile created based upon the interaction, for example based upon the IP address location of the viewer. In a preferred embodiment, the psychographic analyzer will cross-reference data submitted to the survey or contest to update psychographic information previously entered into the database. For example, if a viewer enters in a name, location, date of birth, and gender, that information can be cross-referenced to an existing psychographic profile or personal information in the database. In an alternative embodiment, an open standard technology for a single sign-on campaign could be used to cross-reference users of the widget.

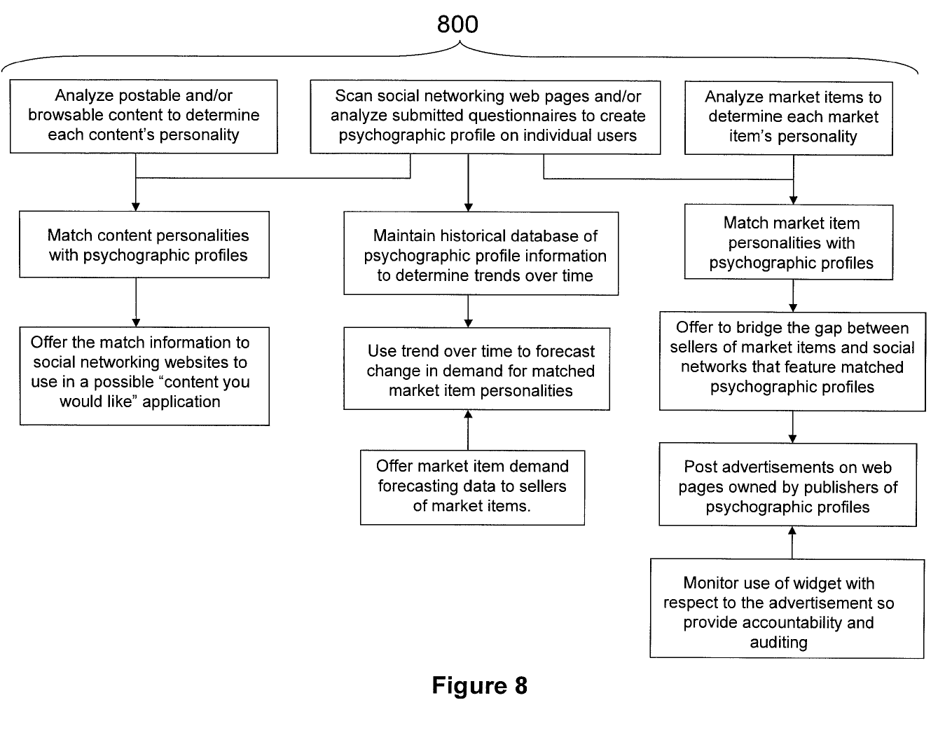

In FIG. 8, various methods of leveraging the disclosed technology to create profit for a business are presented in flowchart 700.

Thus, specific embodiments and applications of facilitating advertising and marketing objectives have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of facilitating advertising and marketing objectives on a public package switched network, comprising:
automatically assigning at least one psychographic profile to each of a plurality of publishers on a social networking site, based at least in part on personal information that each of the plurality of publishers publish on their own web pages;
characterizing a personality of a market item;
matching the personality with a subset of the profiles; and
providing advertisements for posting on the web pages of at least some of publishers that correspond with the subset.

2. The method of claim 1, wherein the personal information comprises content created by non-publishers.

3. The method of claim 1, wherein the personal information comprises at least one of a video, a podcast, an image, a text object, an animation, and an audio file.

4. The method of claim 1, further comprising dynamically altering the advertisements as the personal information changes.

5. The method of claim 1, further comprising maintaining a historical database of historical personal information from each of the publishers.

6. The method of claim 1, further comprising maintaining a historical database of historical psychographic profiles on each of the plurality of publishers.

7. The method of claim 6, further comprising matching the personality with a subset of the historical psychographic profiles.

8. The method of claim 1, wherein the psychographic profiles are based at least in part on non-published personal information that each of the plurality of publishers has provided to an operator of the social networking site.

9. The method of claim 1, wherein matching the personality with a subset of profiles comprises matching tag of a personality with a tag of a profile.

10. The method of claim 9, wherein the tag comprises a description of subject matter.

11. The method of claim 9, wherein the tag comprises a description of a targeted entity.

12. The method of claim 1 further comprising providing a user interface to a third-party content provider that sends content to a publisher's web page.

13. The method of claim 12, wherein the content provider sends content to the publisher's web page.

14. A method of producing revenue for a social networking web site, comprising:
performing an automated analysis on a set of at least 1,000 publishers on the social networking site, wherein the analysis assigns at least one psychographic profile to each analyzed publisher;
characterizing a personality of a market item;
matching the personality with at least one psychographic profile; and
charging an advertiser of the market item to post an advertisement on web pages individually associated with each of the set of publishers.

15. The method of claim 14, further comprising monitoring interactions between at least one of the set of publishers and the advertisement to produce interaction data.

16. The method of claim 15, further comprising charging the advertiser for access to the interaction data.

17. The method of claim 14, wherein the advertisement comprises a market survey that provides additional personal information.

18. A method of producing revenue for a social networking web site, comprising:
scanning a plurality of web pages containing personal information on publishers to identify an owner of a market item;
performing an automated analysis of the publisher's web page to create a psychographic profile; and
charging an advertiser of the market item for the psychographic profile.

19. The method of claim 18, wherein the psychographic profile comprises at least one of a hobby, an interest, a show, a band, a song, a magazine, an animal, and a book.

20. The method of claim 18, wherein the automated analysis is performed repeatedly over a period of time.
